(19) United States
(12) Patent Application Publication
(10) Pub. No.: US 2008/0160851 A1
(43) Pub. Date: Jul. 3, 2008

(54) Textiles Having a High Impedance Surface

(75) Inventors: Gregory J. Dunn, Arlington Heights, IL (US); Remy J. Chelini, Crystal Lake, IL (US); Howard W. Davis, Clarendon Hills, IL (US); Jeffrey M. Petsinger, Wayne, IL (US); John A. Svigelj, Crystal Lake, IL (US)

Correspondence Address: PRASS & IRVING LLP, 2661 Riva Road, Bldg. 1000, Suite 1044, ANNAPOLIS, MD, 21401, US

(73) Assignee: Motorola, Inc., Schaumburg, IL (US)

(21) Appl. No.: 11/616,853

(22) Filed: Dec. 27, 2006

(51) Int. Cl. B32B 5/02

(52) U.S. Cl. 442/110

(57) ABSTRACT

A textile may include conductive matter and a high impedance surface defined at least in part by the conductive matter.

### TECHNICAL FIELD

The present invention is directed to textiles having a high impedance surface. More particularly, the present invention is directed to wearable and portable textiles having conductive matter that, at least in part, defines the high impedance surface.

### BACKGROUND

A conventional ground plane must be placed a quarter wavelength away from an associated antenna to avoid having its image currents cancel the currents in the antenna, which would result in poor radiation efficiency. Conventional flat metal ground planes also support the propagation of surface waves, which cause multipath interference and backward radiation.

Some conventional high impedance antenna surfaces have been designed to address some of these shortcomings of conventional ground planes. Some high impedance surfaces are fabricated as printed circuit boards. A series of U.S. patents to Sievenpiper, the most recent being U.S. Pat. No. 6,739,028, describe a high impedance surface comprising one or more layers of periodic arrays of flat plates. Each plate may be connected to a backside ground plane by one or more conductive posts. Because the image currents of the board are not phase reversed, the high impedance surface can be placed directly against an antenna.

The conventional high impedance antenna surfaces used for many telecommunications applications require a relatively large area, especially for frequencies below 10 GHz as used in many cellular, two-way radio, and satellite communications systems. This large area requirement is directly contrary to the present-day desire to reduce the size of personal communications devices and other personal electronics.

It may be desirable to provide a textile having a high impedance antenna surface, where the textile is a woven, non-woven, knitted, felted, or foamed material that can be fabricated into a wearable garment or portable article. It may be desirable to exploit the substantial surface area of a wearable garment or portable article while not being restricted by the flexibility, durability, and launderability of the garment or article.

### SUMMARY OF THE INVENTION

According to various aspects of the disclosure, a textile may include conductive matter and a high impedance surface defined at least in part by the conductive matter.

In accordance with some aspects of the disclosure, a textile having a high impedance antenna surface may comprise a conductive fabric ground plane, one or more layers of conductive fabric plate arrays, and one or more non-conductive fabric layers interleaved between the conductive fabric ground plane and the one or more layers of conductive fabric plate arrays.

In various aspects of the disclosure, a textile may comprise a high impedance surface and an antenna mounted on the high impedance surface.

### BRIEF DESCRIPTION OF THE DRAWINGS

FIG. 1 is a diagrammatic perspective view of an exemplary textile in accordance with various aspects of the disclosure;

FIG. 2 is a partial and diagrammatic perspective view of exemplary components of an exemplary textile in accordance with various aspects of the disclosure;

FIG. 3 is a partial and diagrammatic perspective view of exemplary components of an exemplary textile in accordance with various aspects of the disclosure;

FIG. 4 is a partial and diagrammatic perspective view of exemplary components of an exemplary textile in accordance with various aspects of the disclosure;

FIG. 5 is a partial and diagrammatic perspective view of exemplary components of an exemplary textile in accordance with various aspects of the disclosure;

FIG. 6 is a partial and diagrammatic perspective view of exemplary components of an exemplary textile in accordance with various aspects of the disclosure; and

FIG. 7 is a diagrammatic perspective view of an exemplary textile in accordance with various aspects of the disclosure.

### DETAILED DESCRIPTION

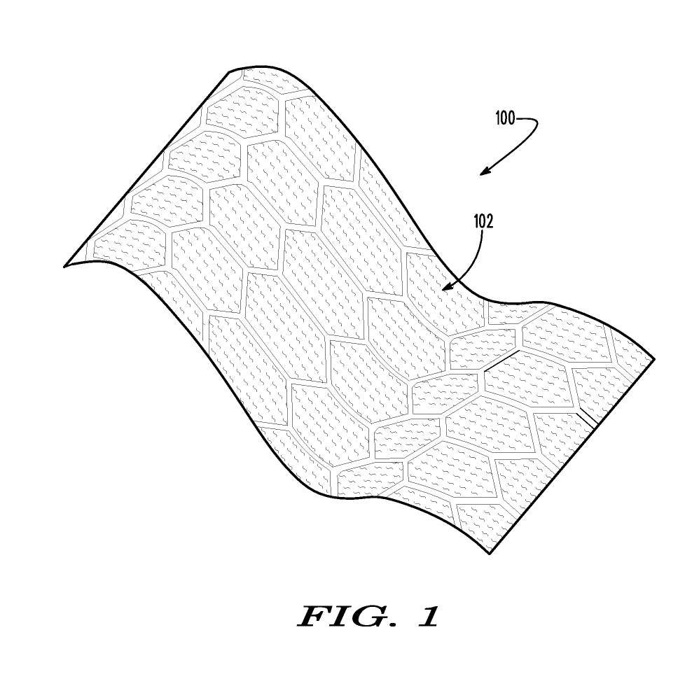

An exemplary embodiment of a textile 100 having a high impedance surface 102 is illustrated in FIG. 1. According to various aspects, the textile 100 may be used in the manufacture of clothing, luggage, and collapsible antenna structures. Bolts of the textile 100 can be cut and sewn to manufacture the articles of clothing, luggage, and collapsible structures that may be stowed in small volumes. According to some aspects, the textile 100 may be flexible, durable, and/or launderable.

According to various aspects, the high impedance surface 102 may be defined at least in part by conductive matter. As described in more detail below, the conductive matter may comprise conductive thread, a conductive fabric, or a conductive paste.

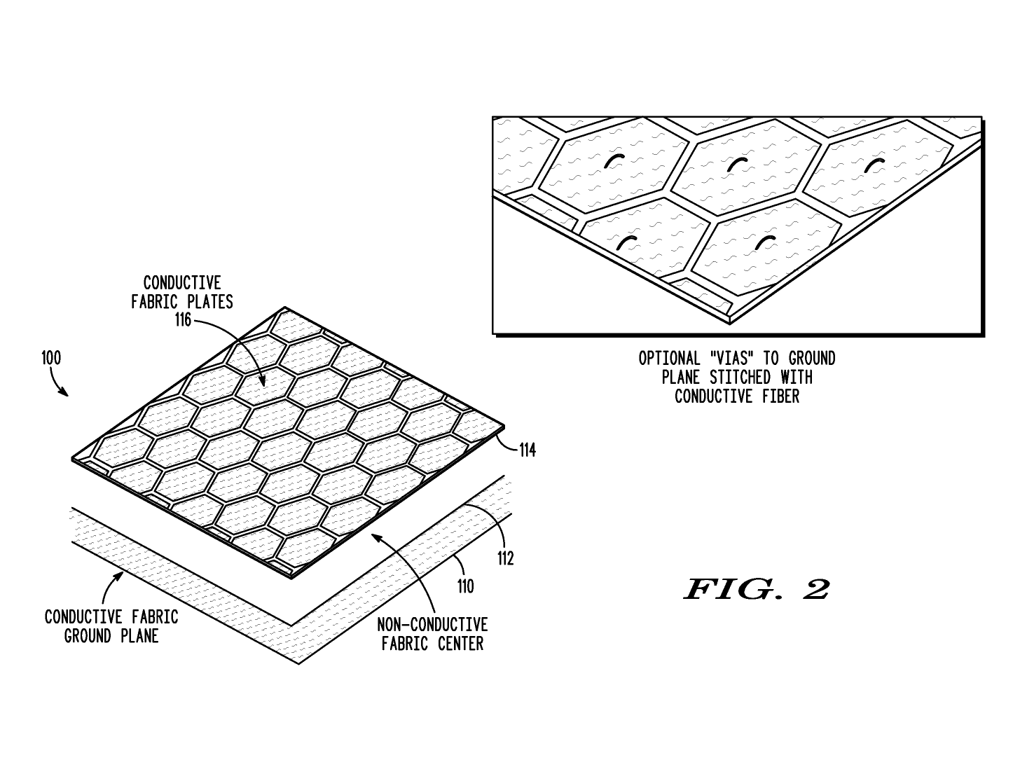

As shown in FIG. 2, according to various aspects, the textile 100 may comprise a conductive fabric ground plane 110, for example a sheet of Flectron-N nickel/copper-plated Dacron polyester taffeta from Laird Technologies of St Louis, Mo., a sheet of EeonTex doped polypyrrole-coated polyester or nylon from Eeonyx Corporation of Pinole, Calif., or a non-conductive fabric such as woven or non-woven nylon or polyester substantially continuously coated with a conductive paste such as an epoxy or phenolic resin filled with silver flakes, or a conductive paste that is an unfilled conductive polymer resin such as polypyrrole. The textile may also comprise a non-conductive fabric center 112, for example conventional felt, soft foam, or polyester fleece, and a layer 114 of a periodic array of conductive fabric plates 116. The non-conductive fabric center 112 may comprise a dielectric spacer fabric interleaved or sandwiched between the conductive fabric ground plane 110 and the layer 114 of conductive fabric plates 116. The fabric plates 116 include flexible or compliant conductive matter that defines, at least in part, the high impedance surface 102.

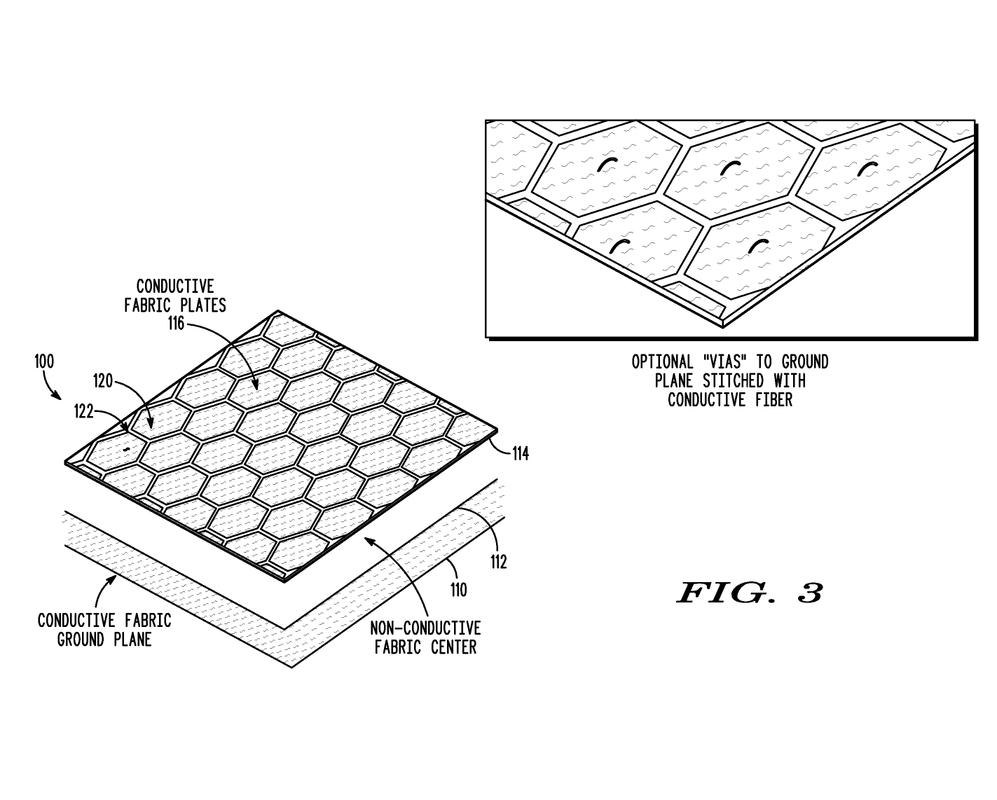

In one exemplary aspect, as shown in FIG. 3, the fabric plates 116 may comprise a conductive thread 120, such as ARACON conductive thread from DuPont, stitched on a non-conductive fabric 122 such as woven or non-woven polyester or natural fiber such as wool or cotton. For example, the conductive thread 120 may be embroidered or woven on the non-conductive fabric 122. It should be appreciated that embroidery or weaving can be used to create space-filling curves that have long lengths in a small footprint, such as, for example, Hilbert curves, thus resulting in a low resonant frequency with respect to the size of the footprint.

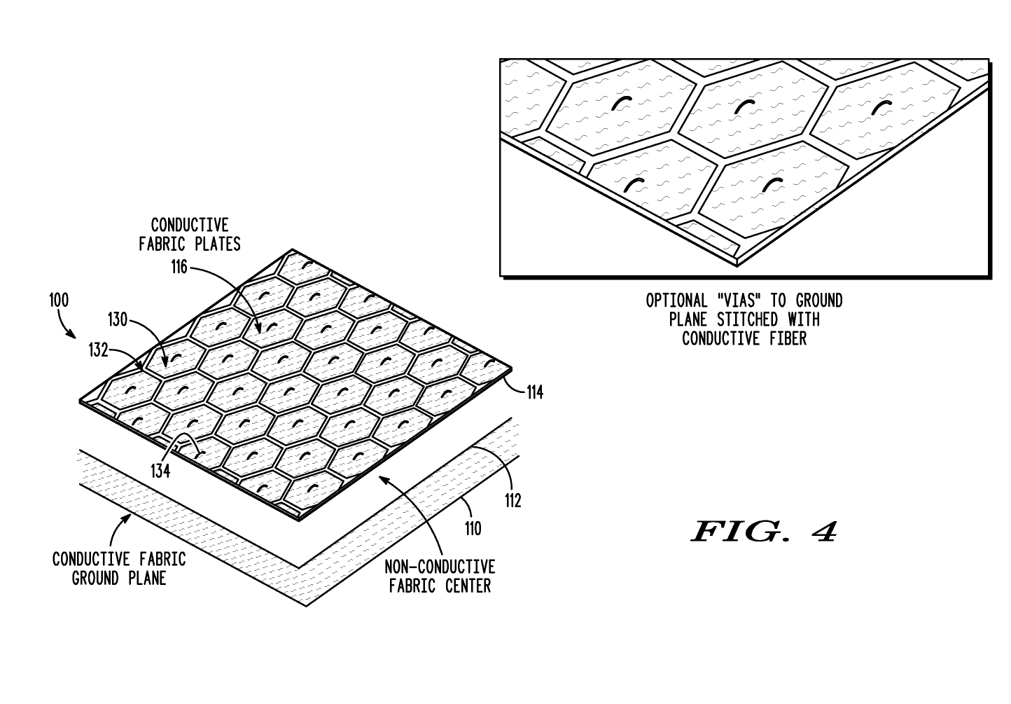

Referring to FIG. 4, the fabric plates 116 may comprise a conductive fabric 130 patterned additively, semi-additively, or subtractively by photolithography. The pattern includes non-conductive regions 132 resulting from the photolithography. In some aspects, the conductive fabric 130 may comprise metal-coated fibers, such as, for example, Copper-Nickel-coated Dacron polyester taffeta or the like. Additive patterning refers to the use of a resist during all plating steps such that metal is not deposited in non-conductive regions 132. Semi-additive patterning refers to the use of a resist during at least one of a plurality of plating steps, such that only a thin and/or selectively etchable metal is deposited in, and subsequently removed by etching from, non-conductive regions 132. Subtractive patterning refers to the use of a resist during one or more etching steps to remove substantially uniformly deposited metal from non-conductive regions 132.

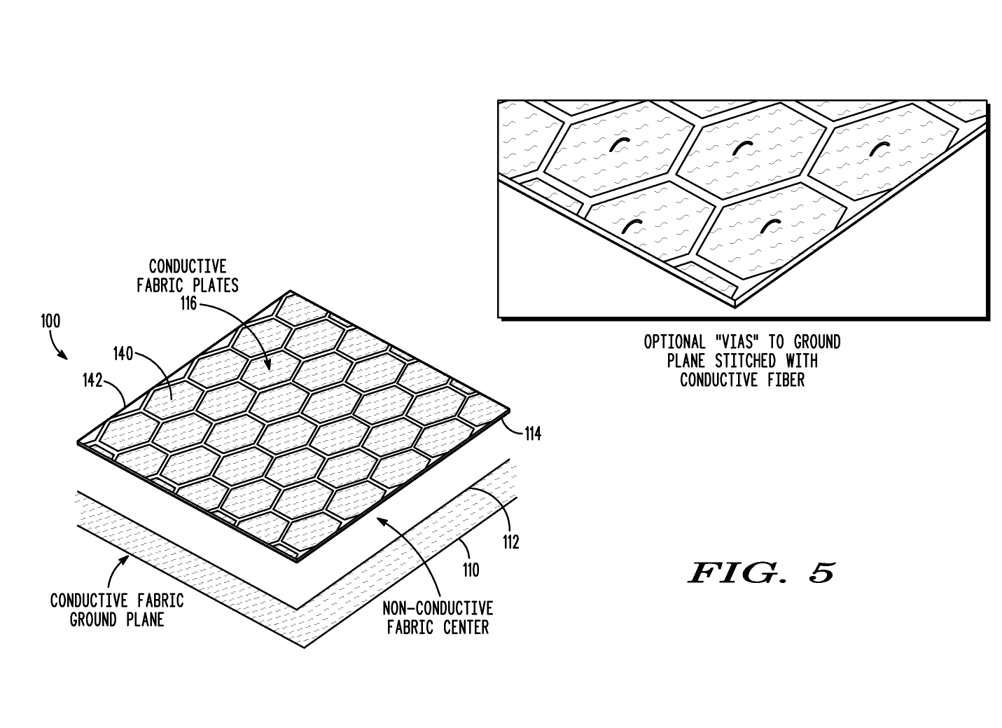

Referring now to FIG. 5, the fabric plates 116 may comprise a conductive paste 140, for example, a conductive polymer paste such as an epoxy or phenolic resin filled with silver flakes, or an unfilled conductive polymer resin such as polypyrrole, screen-printed on a non-conductive fabric 142 such as woven or non-woven polyester or nylon.

It should be appreciated that the textile 100 may optionally include one or more vias 134 formed by conductive thread stitched to the ground plane 110 and the conductive matter of the conductive fabric plates 116 described above (vias are shown only in FIG. 4 for clarity purposes).

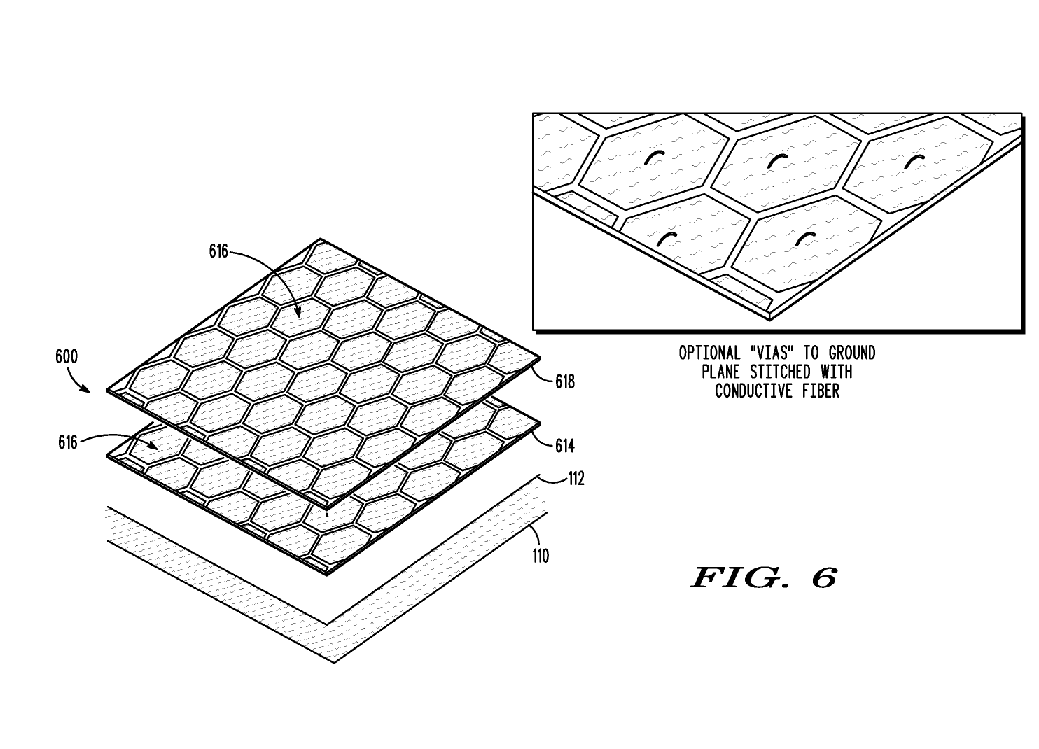

FIG. 6 illustrates another exemplary aspect of the disclosure, wherein a textile 600 comprises a conductive fabric ground plane 110, a non-conductive fabric center 112, a first layer 614 of a periodic array of conductive fabric plates 616, and a second layer 618 of a periodic array of conductive fabric plates 616. The first and second layers 614, 618 may be electrically isolated from one another by the non-conductive fabric on which they are directly formed. The first and second layers 614, 618 comprise hexagonal plates. The hexagonal plates of the second layer 618 are offset from the hexagonal plates of the first layer 614, such that each hexagon of one layer partially overlaps three hexagons of the other layer.

In some aspects, the first and second layers may comprise arrays of square or rectangular plates. With squares or rectangles, the offset would typically cause each square or rectangle to partially overlap four squares or rectangles of the other layer. It should be appreciated that a textile may comprise more than two layers of conductive fabric plate arrays. Regardless of the number of layers of conductive fabric plate arrays, the layers are electrically isolated from each other.

According to some aspects, the layers of conductive fabric plate arrays may be electrically isolated, for example, by interleaving or sandwiching a second non-conductive center between them. Alternatively, the conductive fabric plate arrays may be electrically isolated from each other by the non-conductive fabric on which they are directly formed, as in the embodiment of FIG. 6. For example, if the conductive plate arrays are formed by screen-printing conductive silver paste onto nylon, the nylon substrate may provide the required electrical isolation when the two layers are stacked. In another aspect, the conductive plate arrays may be formed on opposing surfaces of a single sheet of non-conductive fabric, for example by screen-printing conductive silver paste onto both surfaces of a sheet of nylon. All of these alternative aspects have in common the interleaving of layers of non-conductive fabric with layers of conductive plate arrays and the conductive fabric ground plane.

A person skilled in the art will appreciate that a high impedance surface comprising a single layer of plates depends upon the fringing capacitance between plates lying in the same plan, i.e., the edge-to-edge capacitance. A high impedance surface with a second, offset layer of plates provides parallel plate series capacitance between the plates of the first layer. This parallel plate series capacitance is typically substantially greater in magnitude that the fringing capacitance of the single-layer construction, thereby reducing the resonant frequency of the high impedance surface.

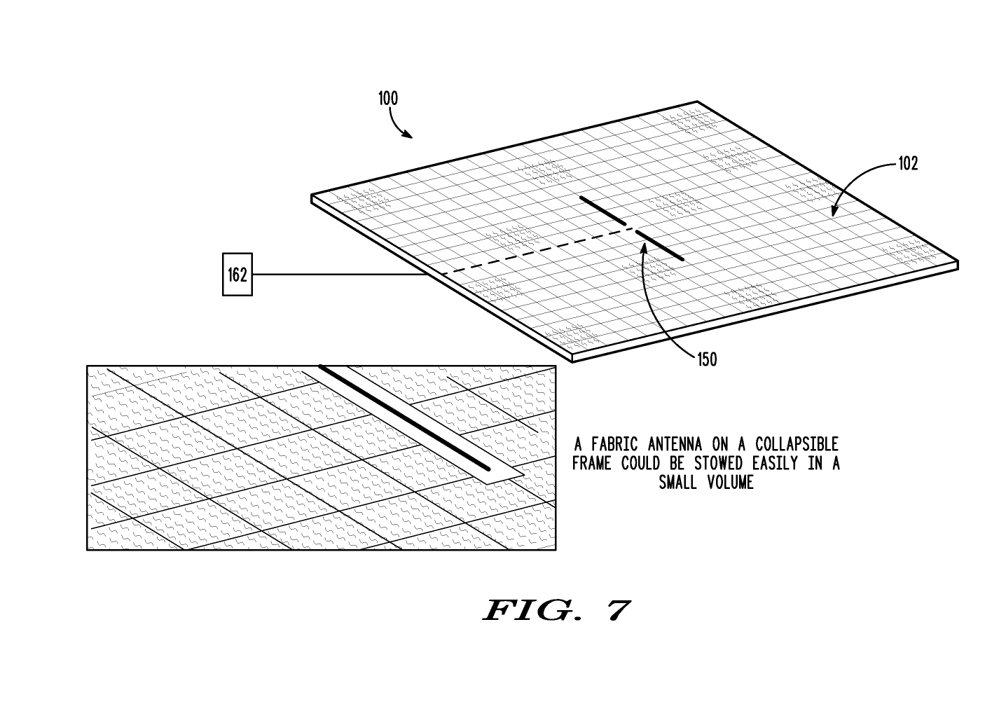

As shown in FIG. 7, the textile 100 may include an antenna 150 mounted on the high impedance surface 102. The antenna 150 may comprise a dipole antenna as illustrated in FIG. 7. It should be appreciated that, according to various aspects, the antenna 150 may comprise a crossed dipole, a bow-tie, a spiral, a patch antenna, a patch antenna with a repeating unit cell having a desired fabric pattern, or the like. The high impedance surface may be configured to prevent detuning of the antenna 150 via interaction with a body of a user.

The textile 100 may comprise an interface configured to interconnect the antenna 150 with an electronics assembly 162. The electronics assembly 162 may be held by a user or stowed in a pocket of the textile 100 or some other worn or carried article, or it may be partially or fully integrated into the worn or carried article. According to various aspects, the electronics assembly may comprise a cellular telephone or smartphone, a two-way radio, a satellite communication device, a personal information device or personal digital assistant, or any other personal communication device.

The textile 100 with high impedance surface 102 can be placed directly against the antenna 150 because there is no phase reversal that is typical of a normal ground plane. Although the proximity of a mounted antenna to the body changes as the user moves, the high impedance surface 102 may also prevent detuning of antennas caused by the body of a user. Thus, the textile 100 and a low profile antenna 150 accommodate the desire for small form factor communications products, while taking advantage of the huge surface area provided by a garment or other fabric structure in comparison with the size of typical portable electronics housings.

It should be appreciated that the high impedance surface 102 of the textile 100 may suppress surface waves of any antenna on the textile. Accordingly, a plurality of antennas may be mounted on the high impedance surface 102 without causing mutual interference problems. The suppression of surface waves may also improve the performance of patch antennas.

It will be apparent to those skilled in the art that various modifications and variations can be made in the devices and methods of the present disclosure without departing from the scope of the invention. Other embodiments of the invention will be apparent to those skilled in the art from consideration of the specification and practice of the invention disclosed herein. It is intended that the specification and examples be considered as exemplary only.

What is claimed is:

1. A textile comprising:
conductive matter; and
a high impedance surface defined at least in part by the conductive matter.

2. The textile of claim 1, further comprising:
a conductive fabric ground plane;
at least one layer comprising a conductive fabric plate array, said conductive fabric plate array including the conductive matter; and
at least one layer of non-conductive fabric interleaved between the conductive fabric ground plane and the at least one layer comprising a conductive fabric plate array.

3. The textile of claim 2, wherein the conductive matter comprises one of a conductive thread stitched on a non-conductive fabric, a conductive fabric, and a conductive paste.

4. The textile of claim 2, wherein the conductive matter comprises a conductive thread embroidered on the non-conductive fabric.

5. The textile of claim 2, wherein the conductive matter comprises a conductive fabric comprising metal-coated fibers.

6. The textile of claim 2, wherein the conductive matter comprises a conductive paste screen-printed on a non-conductive fabric.

7. The textile of claim 1, further comprising at least one via.

8. The textile of claim 7, wherein the at least one via is formed by conductive thread stitched to the conductive fabric ground plane and the conductive matter.

9. The textile of claim 1, further comprising at least one antenna mounted on the high impedance surface.

10. The textile of claim 9, wherein the textile comprises a garment, the high impedance surface being configured to prevent detuning of the antenna via interaction with a body of a user.

11. A textile having a high impedance antenna surface, the textile comprising:
a conductive fabric ground plane;
one or more layers of conductive fabric plate arrays; and
one or more layers of non-conductive fabric interleaved between the conductive fabric ground plane and the one or more layers of conductive fabric plate arrays.

12. The textile of claim 11, wherein the conductive fabric ground plane comprises one of a conductive thread stitched on a non-conductive fabric, a conductive fabric, and a conductive paste screen-printed on a non-conductive fabric.

13. The textile of claim 12, wherein the conductive fabric ground plane comprises a conductive thread embroidered on the non-conductive fabric.

14. The textile of claim 12, wherein the conductive fabric ground plane comprises a conductive fabric including metal-coated fibers.

15. The textile of claim 11, further comprising at least one antenna mounted on the high impedance surface.

16. The textile of claim 15, wherein the textile comprises a garment, the high impedance surface being configured to prevent detuning of the antenna via interaction with a body of a user.

17. The textile of claim 11, further comprising at least one via.

18. The textile of claim 17, wherein the at least one via is formed by conductive thread stitched to the conductive fabric ground plane and the conductive matter.

19. A textile, comprising:
a high impedance surface comprising a conductive fabric; and
at least one antenna mounted on the high impedance surface.

20. The textile of claim 19, wherein the at least one antenna comprises a plurality of antennas.
